(19) United States
(12) Patent Application Publication
(10) Pub. No.: US 2024/0369386 A1
(43) Pub. Date: Nov. 7, 2024

(54) ENCODER

(71) Applicant: Panasonic Intellectual Property Management Co., Ltd., Osaka (JP)

(72) Inventors: Hideo YAMAGUCHI, Fukuoka (JP); Shinichi TAKIGAWA, Osaka (JP)

(21) Appl. No.: 18/685,825

(22) PCT Filed: Aug. 19, 2022
(86) PCT No.: PCT/JP2022/031312

§ 371 Date: Feb. 22, 2024

(30) Foreign Application Priority Data
Sep. 3, 2021 (JP) 2021-143582

(51) Int. Cl. G01D 5/347; G01B 11/26

(52) U.S. Cl. CPC G01D 5/3473; G01B 11/26

(57) ABSTRACT

An encoder includes: a rotary plate including a pattern for detecting rotational displacement; a light source that emits light onto the pattern; a light-receiving part including a light-receiving region that receives the light that is emitted from the light source and travels via the rotary plate; a fixed body in which the light-receiving part is provided; and an opposing component that opposes the pattern. The opposing component is disposed between the rotary plate and the fixed body.

### TECHNICAL FIELD

The present disclosure relates to an encoder, and in particular, relates to an optical encoder.

### BACKGROUND ART

Motors, such as servomotors are incorporated in, robots, machine tools, or the like. Rotating encoders (rotary encoders) are used in servomotors to detect rotational displacement, such as angle of rotation or the like. The encoding methods of encoders include optical, magnetic, and electric inductive methods of encoding. Of these, the known types of optical encoders include optically-transmissive and optically-reflective encoders.

An optically-transmissive rotary encoder includes a rotary plate in which a plurality of light-transmissive portions and a plurality of non-light-transmissive portions arranged in a predetermined pattern as a code pattern for detecting rotational displacement are provided, and a substrate in which a light-receiving part is provided. In an optically-transmissive rotary encoder, an angle of rotation is detected by emitting light toward a code pattern of a rotary plate, and receiving the light that passes through light-transmissive portions at a light-receiving part.

In contrast, an optically-reflective rotary encoder includes a rotary plate in which a plurality of light-reflective portions and a plurality of non-light-reflective portions arranged in a predetermined pattern as a code pattern for detecting rotational displacement are provided, and a substrate in which a light-receiving part is provided. In an optically-reflective rotary encoder, an angle of rotation is detected by emitting light toward a code pattern of a rotary plate, and receiving the light reflected by light-reflective portions at a light-receiving part.

In recent years, there has been a demand for high-resolution encoders. As examples of such optical encoders with high resolution, encoders configured to combine digital methods and analog methods of encoding have been proposed. Specifically, an optically-reflective encoder is known that includes a rotary plate in which an absolute pattern (digital portion) and an incremental pattern (analog portion) are provided as code patterns for detecting rotational displacement (Patent Literature (PTL) 1, for example). An absolute pattern is a pattern used for digital detection of an absolute angular position, and an M-sequence code (M-code) or the like is used, for example. Furthermore, an incremental pattern is a pattern used for analog detection of a relative angular position, and light-reflective portions and non-light-reflective portions alternately provided at an even pitch over the entire circumference of a rotary plate are used, for example. Here, a sine/cosine analog signal for which one period is equivalent to a single pitch of M-code that corresponds to a digital signal is optically read. Specifically, the single pitch of the M-code is further subdivided. This makes it possible to realize an encoder with high resolution.

### CITATION LIST

### Patent Literature

[PTL 1] Japanese Unexamined Patent Application Publication No. 2019-211361

### SUMMARY OF INVENTION

### Technical Problem

In recent years, there has been increasing demand for encoders with even higher resolution. In view of this, further miniaturization of code patterns (absolute patterns and incremental patterns) for detecting rotational displacement is being considered. However, when a code pattern is miniaturized, the code pattern becomes even more susceptible to the effects of foreign objects deposited on the code pattern.

In such a case, when a foreign object deposited on an absolute pattern (digital portion) of M-code, or the like, is smaller than the minimal unit pattern corresponding to one bit used to determine if a value is 0 or 1, the effects of the foreign object can be reduced by performing error correction through signal processing in which an error correction function is used. However, when a foreign object larger than the minimal unit pattern corresponding to one bit is deposited on the code pattern, the error correction function will not be able to handle this situation, and an error will be output by an anomaly determination circuit, thereby causing the encoder to stop functioning.

Furthermore, when a foreign object is deposited on an incremental pattern (analog portion), regardless of the size of the foreign object, the waveform accuracy of the sine/cosine analog signal will decrease. As a result, the resolution for detecting rotational position will decrease.

Accordingly, when a code pattern (absolute pattern or incremental pattern) is miniaturized to achieve a high resolution, the code pattern becomes less robust to foreign objects deposited on the code pattern.

The present disclosure has been conceived to overcome the above-mentioned problem, and has an object to provide an encoder that is highly robust to foreign objects.

### Solution to Problem

In order to achieve the above-mentioned object, an encoder according to a first aspect of the present disclosure includes: a rotary plate including a pattern for detecting rotational displacement; a light source that emits light onto the pattern; a light-receiving part including a light-receiving region that receives the light that is emitted from the light source and travels via the rotary plate; a fixed body in which the light-receiving part is provided; and an opposing component that opposes the pattern. The opposing component is disposed between the rotary plate and the fixed body.

### Advantageous Effects of Invention

With the present disclosure, an encoder that is highly robust to foreign objects can be realized.

### BRIEF DESCRIPTION OF DRAWINGS

FIG. 1 is a perspective view of an encoder according to Embodiment 1.

FIG. 2 is an exploded perspective view of the encoder according to Embodiment 1.

FIG. 3 is a cross-sectional view of the encoder according to Embodiment 1.

FIG. 4 is a diagram illustrating a code pattern of a rotary plate included in the encoder according to Embodiment 1.

FIG. 5 is a perspective view from above of an opposing component included in the encoder according to Embodiment 1.

FIG. 6 is a perspective view from below of the opposing component included in the encoder according to Embodiment 1.

FIG. 7 is a diagram for describing the operation of the encoder according to Embodiment 1.

FIG. 8 is a diagram illustrating a configuration of an encoder in a comparative example.

FIG. 9 is an exploded perspective view of an encoder according to Embodiment 2.

FIG. 10 is a cross-sectional view of the encoder according to Embodiment 2.

FIG. 11 is an enlarged cross-sectional view of an encoder according to a variation of Embodiment 2.

FIG. 12 is an exploded perspective view of an encoder according to Embodiment 3.

FIG. 13 is a cross-sectional view of an encoder according to a variation.

### DESCRIPTION OF EMBODIMENTS

Hereinafter, embodiments of the present disclosure will be described with reference to the drawings. It should be noted that the embodiments described below merely illustrate specific examples of the present disclosure. Accordingly, the numerical values, shapes, materials, elements, arrangement and connection states of the elements, etc., described in the following embodiments are mere examples, and are therefore not intended to limit the present disclosure. Accordingly, among elements in the following embodiments, those not appearing in any of the independent claims defining the broadest concepts of the present disclosure will be described as optional elements.

It should be noted that the respective figures are schematic diagrams and are not necessarily precise illustrations. Therefore, the scaling, and so on, depicted in the drawings is not necessarily uniform. Moreover, elements that are substantially the same are given the same reference signs in the respective figures, and redundant descriptions are omitted or simplified.

### Embodiment 1

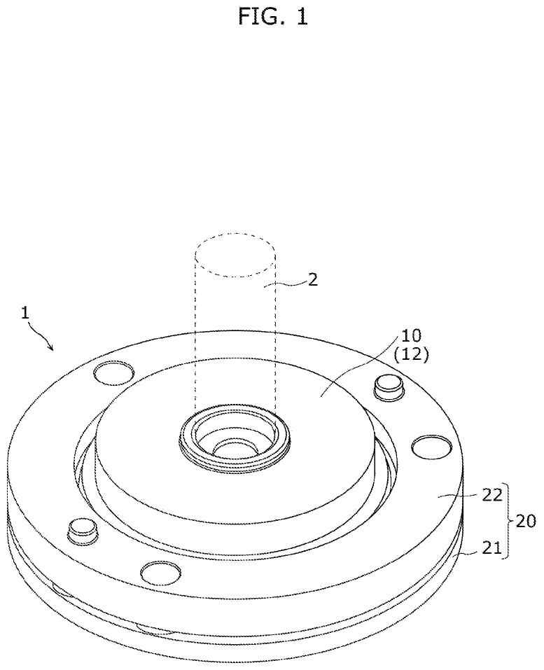

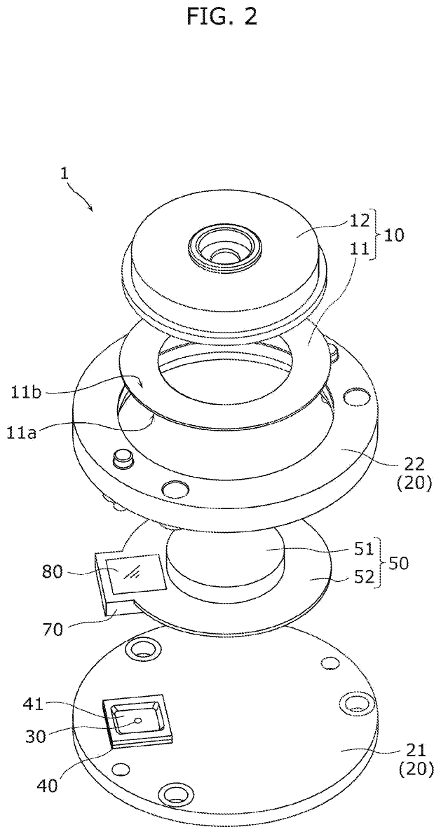

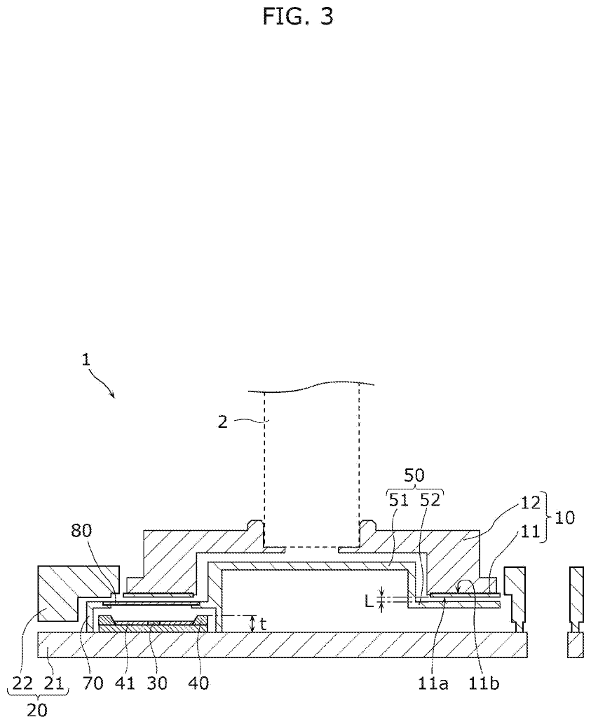

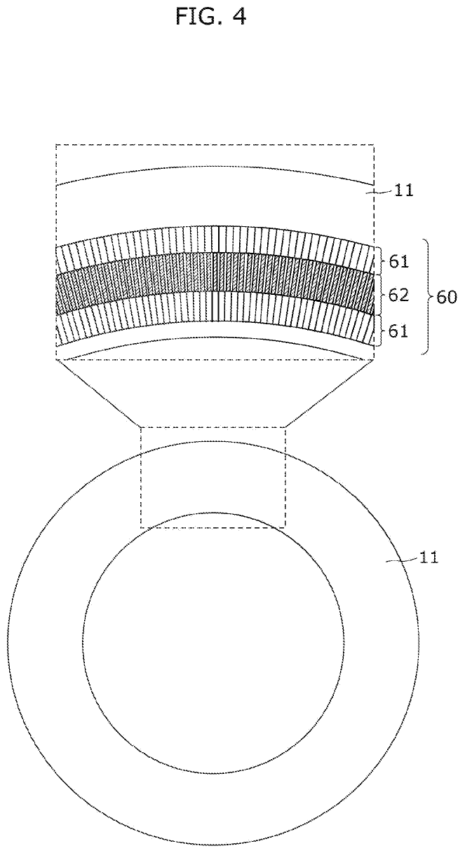

First, encoder 1 according to Embodiment 1 will be described with reference to FIG. 1 through FIG. 4. FIG. 1 is a perspective view of encoder 1 according to Embodiment 1. FIG. 2 is an exploded perspective view of encoder 1. FIG. 3 is a cross-sectional view of encoder 1. FIG. 4 is a diagram illustrating a code pattern of rotary plate 11 included in encoder 1. Note that in FIG. 3, only those portions included in the cross section are illustrated in the figure.

Encoder 1 according to the present embodiment is an optical rotary encoder. Specifically, encoder 1 is an optically-reflective rotary encoder. Encoder 1 is used in combination with a motor, such as a servomotor, for example.

As illustrated in FIG. 1 through FIG. 3, encoder 1 according to the present embodiment includes rotary body 10, fixed body 20, light source 30, light-receiving part 40, and opposing component 50.

Rotary body 10 is an example of a rotary component that rotates. Rotary body 10 is fixed to rotary shaft 2, and rotates together with rotary shaft 2. Rotary shaft 2 is attached to a central portion of rotary body 10. Accordingly, the rotation of rotary shaft 2 causes rotary body 10 to rotate about rotary shaft 2. Rotary shaft 2 is a rotary shaft (shaft) of a motor, for example. Here, encoder 1 detects rotational displacement, such as the angle of rotation, the rate of rotation, or the like of rotary shaft 2 of the motor.

Although the direction of rotation of rotary body 10 includes both clockwise and counter-clockwise directions, this example is not limiting. For example, the direction of rotation of rotary body 10 may include only one of a clockwise or a counter-clockwise direction.

Rotary body 10 includes rotary plate 11 and support component 12 that supports rotary plate 11. Accordingly, rotary plate 11 and support component 12 rotate together with rotary shaft 2.

Rotary plate 11 is a plate-shaped substrate. As an example, rotary plate 11 is an annular substrate having a constant width, but this example is not limiting. For example, rotary plate 11 may be a circular substrate. Rotary plate 11 is a metal substrate made of a metal material, a resin substrate made of a resin material, a glass substrate made of a glass material, or a ceramic substrate made of a ceramic material. In the present embodiment, rotary plate 11 is a metal substrate.

As illustrated in FIG. 4, rotary plate 11 includes code pattern 60. Code pattern 60 is a pattern for detecting rotational displacement, such as angle of rotation, rotational position, or the like, and indicates information on rotational displacement, such as angle of rotation, rotational position, or the like. Code pattern 60 is provided in first surface 11a (see FIG. 3) on the side of rotary plate 11 facing fixed body 20. Encoder 1 can detect rotational displacement, such as the angle of rotation (rotational position) or the like of rotary plate 11 by using code pattern 60. Code pattern 60 includes a plurality of unit patterns of predetermined shapes provided in single rows extending along the circumferential direction (direction of rotation) of rotary plate 11 to correspond to the angle of rotation.

As illustrated in FIG. 4, in the present embodiment, code pattern 60 includes absolute patterns 61 and incremental pattern 62. Absolute patterns 61 and incremental pattern 62 are provided at different positions in the radial direction of rotary plate 11. In other words, absolute patterns 61 and incremental pattern 62 are provided in different lanes (tracks) of rotary plate 11.

Absolute patterns 61 are patterns for detecting an absolute position. Specifically, absolute patterns 61 are patterns for detecting an absolute angular position in rotary plate 11. The plurality of unit patterns included in each of absolute patterns 61 are provided in a single row spanning across the entire circumference of rotary plate 11. As an example, absolute patterns 61 are encoded patterns represented by a pseudo-random code, such as an M-code of a predetermined number of bits or the like. It should be noted that absolute patterns 61 are not limited to M-code, and may be Gray code, binary code, binary-coded decimal (BCD) code, or the like.

Incremental pattern 62 is a pattern for detecting a relative position in rotary plate 11. Specifically, incremental pattern 62 is a pattern for detecting a relative angular position in rotary plate 11. The plurality of unit patterns included in incremental pattern 62 are provided in a single row that spans across the entire circumference of rotary plate 11.

Since encoder 1 according to the present embodiment is an optically-reflective encoder, code pattern 60 is configured to include a plurality of light-reflective portions and a plurality of non-light-reflective portions. Specifically, absolute patterns 61 and incremental pattern 62 each include a plurality of light-reflective portions and a plurality of non-light-reflective portions. In the present embodiment, the non-light-reflective portions are light-shielding portions (light-absorbing portions). Accordingly, code pattern 60 is configured as a light-shielding pattern and a light-reflective pattern.

Specifically, absolute patterns 61 and incremental pattern 62 each include a plurality of light-reflective portions and a plurality of light-shielding portions arranged in unit patterns. In absolute patterns 61 and incremental pattern 62, each light-reflective portion and each light-shielding portion is a unit pattern, which is the smallest unit for reading information when detecting the position of rotary plate 11. The space between two adjacent unit patterns is the same for all unit patterns (light-reflective portions and light-shielding portions) in absolute patterns 61 and incremental pattern 62.

In the present embodiment, since each absolute pattern 61 is an M-code, the light-reflective portions and the light-shielding portions of absolute patterns 61 are provided in an iterative manner along the circumferential direction of rotary plate 11 in a sequence that constitutes an encoded pattern, such as an M-code.

The light-reflective portions in incremental pattern 62 are provided in an iterative manner along the circumferential direction of rotary plate 11 to correspond to the angle of rotation. Specifically, incremental pattern 62 is arranged such that the light-reflective portions of incremental pattern 62 and the light-shielding portions of incremental pattern 62 are alternately arranged one by one in an iterative manner.

As illustrated in FIG. 3, rotary plate 11 in which code pattern 60 is provided is fixed to support component 12. Support component 12 is connected to second surface 11b that is on the side of rotary plate 11 facing away from first surface 11a in which code pattern 60 is provided.

Although support component 12 is not limited to any particular shape, in the present embodiment, support component 12 is a flat, bottomed cylinder. Rotary plate 11 is attached to an end portion of support component 12 on the opening portion-side of support component 12. Furthermore, rotary shaft 2 is attached to support component 12. Specifically, rotary shaft 2 is fitted in a hole provided in a central portion of the bottom of support component 12, and fixed to support component 12 by a screw (not illustrated in the figures). Note that although support component 12 is not limited to any particular material, support component 12 is made of a metal material or a resin material, for example.

As illustrated in FIG. 3, fixed body 20 is disposed so as to oppose rotary body 10. Specifically, fixed body 20 is disposed so as to oppose rotary plate 11. Fixed body 20 does not rotate even when rotary body 10 rotates. Fixed body 20 is fixed to a case (not illustrated in the figures) that constitutes a portion of encoder 1 or the motor, for example.

In the present embodiment, fixed body 20 includes fixed plate 21 and fixed frame 22. It should be noted that fixed body 20 may include only fixed plate 21. In such a case, fixed body 20 would be fixed plate 21.

Fixed plate 21 is a circular plate-shaped substrate. Fixed plate 21 is disposed so as to oppose rotary plate 11. Specifically, fixed plate 21 is disposed parallel to rotary plate 11 at a position that is a predetermined distance from rotary plate 11. Furthermore, fixed plate 21 is disposed such that the center of fixed plate 21 and the central axis of rotary shaft 2 coincide with each other. The base material of fixed plate 21 is, for example, a resin substrate, a resin-coated metal substrate, or the like. As an example of fixed plate 21, a printed wiring board in which copper wiring is formed in predetermined patterns can be used, for example.

Fixed frame 22 is configured to surround rotary body 10 and opposing component 50. In the present embodiment, fixed frame 22 is an annular frame. Although fixed frame 22 is made of a resin material, for example, fixed frame 22 may be made of a metal material. Fixed frame 22 is attached to fixed plate 21.

Light-receiving part 40 is provided in fixed body 20. In the present embodiment, light source 30 is also provided in fixed body 20. Specifically, light-receiving part 40 and light source 30 are provided in fixed plate 21 of fixed body 20.

Although not illustrated in the figures, a processor is also provided in fixed plate 21. Light source 30, light-receiving part 40, and the processor are mounted, as a single or multiple electronic components, on fixed plate 21, which is a wiring substrate. Specifically, light source 30, light-receiving part 40, and the processor are mounted on the surface of fixed plate 21 facing rotary plate 11. It should be noted that the processor may be mounted on the surface of fixed plate 21 facing away from rotary plate 11. Furthermore, electronic components other than light source 30, light-receiving part 40, and the processor may be mounted on fixed plate 21.

Light source 30 functions as an irradiating part that emits light onto rotary plate 11. Light source 30 emits light that irradiates code pattern 60 provided in rotary plate 11. In the present embodiment, light source 30 simultaneously emits light onto a plurality of light-reflective portions included in code pattern 60. Here, light source 30 simultaneously emits light onto a plurality of light-reflective portions in a portion of at least one of absolute patterns 61 or incremental pattern 62.

For example, light may be simultaneously emitted only onto a plurality of light-reflective portions in portions of absolute patterns 61, light may be simultaneously emitted only onto a plurality of light-reflective portions in a portion of incremental pattern 62, or light may be simultaneously emitted onto a plurality of light-reflective portions in the portions of absolute patterns 61 and a plurality of light-reflective portions in the portion of incremental pattern 62. It should be noted that when light is simultaneously emitted onto a plurality of light-reflective portions in code pattern 60, light is also emitted onto non-light-reflective portions (light-shielding portions) in code pattern 60.

In the present embodiment, light source 30 is a single point-light source. In other words, light source 30 that is a single-point light source simultaneously causes light to be incident on absolute patterns 61 and incremental pattern 62. Light source 30 is, for example, disposed in a position opposing incremental pattern 62. It should be noted that light emitted from light source 30 may be condensed by a light-collecting component, such as a lens or the like, to irradiate code pattern 60, or may irradiate code pattern 60 without being collected by a light-collecting component.

Light source 30 includes a light-emitting element, such as a light-emitting diode (LED), for example. Light emitted from light source 30 is visible light, such as white light, but this example is not limiting. For example, light emitted from light source 30 may be infrared light or the like.

Furthermore, in the present embodiment, light source 30 is provided in light-receiving part 40 that is a light-receiving module. In other words, light source 30 and light-receiving part 40 are integrated as an optical module. Specifically, light source 30 is disposed in the center of light-receiving part 40.

Light-receiving part 40 includes light-receiving region 41 that receives light that is emitted from light source 30 and travels via rotary plate 11. Specifically, light-receiving region 41 of light-receiving part 40 receives light that is emitted from light source 30 and travels via code pattern 60.

In the present embodiment, since code pattern 60 includes light-reflective portions, light-receiving region 41 of light-receiving part 40 receives light that is emitted from light source 30 and reflected by the light-reflective portions of code pattern 60. Specifically, light-receiving region 41 of light-receiving part 40 simultaneously receives light that is simultaneously reflected by the plurality of light-reflective portions of at least one of absolute patterns 61 or incremental pattern 62.

Light-receiving region 41 of light-receiving part 40 includes, for example, a light-receiving element, such as a photodiode (PD). In the present embodiment, light-receiving region 41 includes a plurality of light-receiving elements. Specifically, light-receiving region 41 includes a first light-receiving element group in which a plurality of first light-receiving elements, which receive light that is emitted from light source 30 and travels via absolute patterns 61, are arranged in the circumferential direction of rotary plate 11, and a second light-receiving element group in which a plurality of second light-receiving elements, which receive light that is emitted from light source 30 and travels via incremental pattern 62, are arranged in the circumferential direction of rotary plate 11.

It should be noted that light-receiving region 41 of light-receiving part 40 need not include a plurality of light-receiving elements. For example, light-receiving region 41 may include an image sensor (imaging element) or the like in which a light-receiving surface, which can simultaneously receive light reflected by each of the plurality of light-reflective portions in absolute patterns 61 and incremental pattern 62, is provided.

Light received by light-receiving part 40 is processed by the processor (not illustrated in the figures) that is electrically connected to light-receiving part 40. Specifically, the processor calculates information on changes in the position of rotary plate 11, based on the position at which light is received on light-receiving region 41 in light-receiving part 40. For example, the processor calculates angle of rotation, rate of rotation, rotational position, rotational speed, or the like, as information on changes in the position of rotary plate 11.

Opposing component 50 is a component, at least a portion of which opposes code pattern 60. In other words, as illustrated in FIG. 3, opposing component 50 opposes first surface 11a of rotary plate 11 in which code pattern 60 (not illustrated in FIG. 3) is provided. In the present embodiment, at least a portion of opposing component 50 is disposed between rotary body 10 and fixed body 20. Specifically, at least a portion of opposing component 50 is disposed between rotary plate 11 in rotary body 10 and fixed plate 21 of fixed body 20.

Opposing component 50 is fixed to fixed body 20. Specifically, opposing component 50 is fixed to fixed plate 21 of fixed body 20. Accordingly, opposing component 50 does not rotate. Although opposing component 50 is a resin-molded part made of a resin material, for example, this example is not limiting. Opposing component 50 may be made of a metal material or the like.

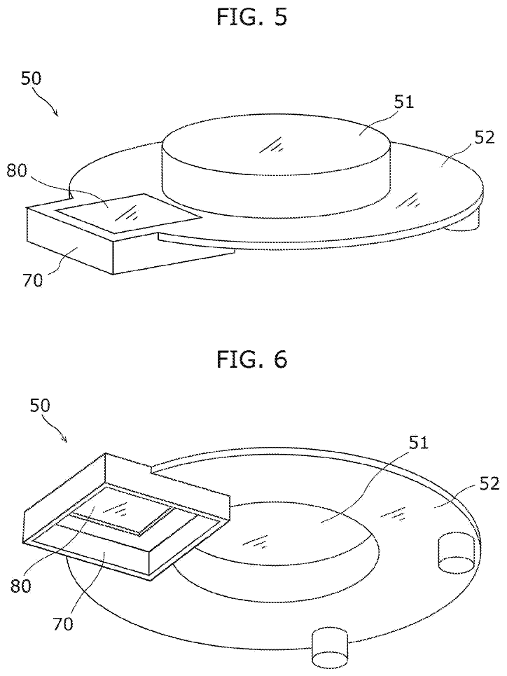

Here, the detailed shape of opposing component 50 will be described with reference to FIG. 2 and FIG. 3, and with reference to FIG. 5 and FIG. 6. FIG. 5 and FIG. 6 are perspective views of opposing component 50.

As illustrated in FIG. 5 and FIG. 6, opposing component 50 according to the present embodiment is hat-shaped, and includes bottomed cylindrical portion 51 and flange portion 52 that extends outward from an edge portion on the opening portion-side of cylindrical portion 51.

As illustrated in FIG. 3, flange portion 52 is disposed between rotary plate 11 and fixed body 20, and opposes code pattern 60. In other words, in opposing component 50, the portion disposed between rotary plate 11 and fixed body 20 is flange portion 52. Specifically, flange portion 52 is disposed between rotary plate 11 and fixed plate 21. Flange portion 52 is of a thin plate-like shape that is annular.

The distance between rotary plate 11 and opposing component 50 is less than or equal to the thickness of light-receiving part 40. Specifically, as illustrated in FIG. 3, where the distance between rotary plate 11 and flange portion 52 in opposing component 50 is denoted by L, and the thickness of light-receiving part 40, which is a light-receiving module, is denoted by t, L≤t.

Thickness t of light-receiving part 40, which is a light-receiving module, is about 1.5 mm. Accordingly, the distance between rotary plate 11 and opposing component 50 is preferably less than or equal to 1.5 mm. Specifically, distance L between rotary plate 11 and flange portion 52 of opposing component 50 is preferably less than or equal to 1.5 mm.

As illustrated in FIG. 3, encoder 1 further includes housing 70 for forming an enclosed space that encloses light-receiving part 40. Housing 70 is a frame that surrounds light-receiving part 40. In the present embodiment, since the external shape of light-receiving part 40 is rectangular, housing 70 is a rectangular frame.

Furthermore, in the present embodiment, housing 70 and opposing component 50 are configured as a single component. Specifically, housing 70 is a portion of opposing component 50. In the present embodiment, housing 70 is provided as a portion of flange portion 52 of opposing component 50.

Encoder 1 further includes glass cover 80 that opposes light-receiving part 40. Glass cover 80 covers light-receiving part 40. Glass cover 80 is a transparent glass plate that allows light emitted from light source 30 toward rotary plate 11 to pass through, and allows light reflected by rotary plate 11 to pass through.

Glass cover 80 is provided in housing 70 by being bonded with an adhesive, such as a thermosetting adhesive, ultraviolet-curing adhesive, or the like. Specifically, glass cover 80 is provided in housing 70 so as to cover an opening of frame-shaped housing 70.

Housing 70 and glass cover 80 constitute a cover that covers light-receiving part 40. Light-receiving part 40 is covered by housing 70 and glass cover 80, thereby causing light-receiving part 40 to become enclosed. In other words, housing 70 and glass cover 80 constitute an enclosed structure that encloses light-receiving part 40. Accordingly, by providing glass cover 80, it is possible to enclose light-receiving part 40 while securing a light path that guides light from light source 30 to rotary plate 11. Note that in the present embodiment, since light source 30 is disposed in light-receiving part 40, housing 70 and glass cover 80 not only enclose light-receiving part 40, but also enclose light source 30.

Furthermore, housing 70 and fixed body 20 are fixed to each other with an adhesive, such as a thermosetting adhesive or an ultraviolet-curing adhesive, for example. Specifically, the adhesive is interposed between an edge portion of housing 70 and a connecting portion of fixed body 20. Accordingly, since the minute gaps between housing 70 and fixed body 20 can be filled with the adhesive, it is possible to improve the degree of sealing of the enclosed space formed by housing 70 and glass cover 80.

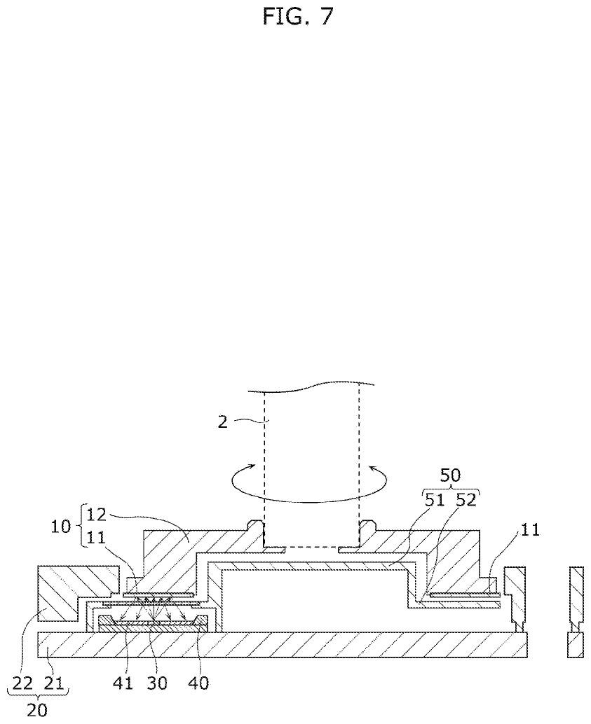

Next, the operation of encoder 1 according to the present embodiment will be described with reference to FIG. 7. FIG. 7 is a diagram for describing the operation of encoder 1 according to Embodiment 1.

As illustrated in FIG. 7, light emitted from light source 30 passes through glass cover 80 and irradiates rotary plate 11 that rotates. Accordingly, the light emitted from light source 30 irradiates code pattern 60 of rotary plate 11. In the present embodiment, the light emitted from light source 30 irradiates absolute patterns 61 and incremental pattern 62.

The light emitted by light source 30 that irradiates code pattern 60 is reflected by light-reflective portions of code pattern 60. In the present embodiment, the light emitted from light source 30 is reflected by each of the light-reflective portions of absolute patterns 61 and incremental pattern 62.

The light emitted from light source 30 and reflected by the light-reflective portions of code pattern 60 passes through glass cover 80 and is received by light-receiving part 40. Specifically, the light emitted from light source 30 and reflected by the light-reflective portions of code pattern 60 enters the light-receiving elements in light-receiving region 41 of light-receiving part 40. It should be noted that light received by light-receiving part 40 is processed by the processor. Accordingly, the angle of rotation, rate of rotation, rotational position, rotational speed, or the like of rotary plate 11 can be calculated.

In this manner, in encoder 1 according to the present embodiment, in addition to receiving light reflected by the light-reflective portions of absolute patterns 61, light reflected by the light-reflective portions of incremental pattern 62 is received. Accordingly, in addition to a digital signal that corresponds to absolute patterns 61, a sine/cosine analog signal that corresponds to incremental pattern 62 is optically read. Here, a sine/cosine analog signal for which one period is equivalent to one pitch of incremental pattern 62 that corresponds to the digital signal is read. Accordingly, an encoder 1 with high resolution can be realized.

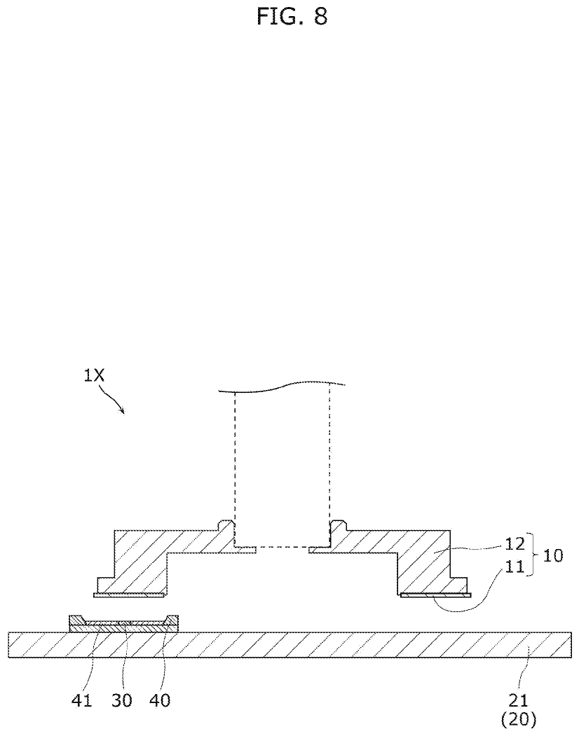

Next, the advantageous effects of encoder 1 according to the present embodiment will be described by comparison with encoder 1X of a comparative example illustrated in FIG. 8. FIG. 8 is a diagram illustrating a configuration of encoder 1X in the comparative example.

As illustrated in FIG. 8, encoder 1X in the comparative example is structured in a manner similar to encoder 1 according to Embodiment 1 above, but in which opposing component 50 is not provided. Furthermore, in encoder 1X in the comparative example, housing 70 and glass cover 80, which are part of opposing component 50, are also not provided. With regard to all other elements, the configuration of encoder 1X in the comparative example is the same as in encoder 1 according to Embodiment 1 above.

In recent years, as there has been increasing demand for encoders with even higher resolution, the miniaturization of code patterns for detecting rotational displacement is being considered. However, when miniaturizing a code pattern, in the event that a foreign object enters between a rotary plate in which the code pattern is provided and a fixed body, and the foreign object becomes deposited on the code pattern, this may make it impossible to accurately calculate rotational displacement. Examples of foreign objects that become deposited on code patterns include portions of components used in encoders, debris generated during assembly work, and the like. For example, a metal foreign object or a resin foreign object constituted by a component burr, chipped debris, or the like may become attached to a code pattern. Furthermore, the foreign object deposited on the code pattern may not fall off even when the rotary plate rotates, and may remain deposited on the rotary plate.

In this manner, when a code pattern is miniaturized to achieve a high resolution, robustness to foreign objects deposited on the code pattern deteriorates.

In view of this, the rotary plate can be brought closer to the fixed body to thereby reduce the distance between the rotary plate and the fixed body in order to prevent foreign objects from entering between the fixed body and the rotary plate in which the code pattern is provided, and becoming deposited on the code pattern.

However, as in encoder 1X as illustrated in FIG. 8, since light-receiving part 40 is provided as an optical module in fixed plate 21 of fixed body 20, there is a limitation on how close rotary plate 11 can be brought to fixed plate 21. That is to say, there is a limitation on how much the space between rotary plate 11 and fixed plate 21, which is a partner component that opposes rotary plate 11, can be reduced. Specifically, the gap between the surfaces of rotary plate 11 and fixed plate 21 (partner component) cannot be made smaller than the thickness of light-receiving part 40 (optical module).

To address this, in encoder 1 according to the present embodiment, opposing component 50 that opposes code pattern 60 is disposed between rotary plate 11 and fixed body 20. Specifically, a portion of opposing component 50 (flange portion 52 in the present embodiment) is disposed between rotary plate 11 and fixed plate 21. In other words, opposing component 50 is interposed between rotary plate 11 and fixed body 20.

With this configuration, since the partner component that opposes rotary plate 11 is opposing component 50, spatial dimensions above rotary plate 11 can be made smaller than that in encoder 1X in the comparative example. In other words, opposing component 50, is a component for decreasing the spatial dimensions above rotary plate 11.

Accordingly, by disposing opposing component 50 between rotary plate 11 and fixed body 20, it is possible to reduce the size of the gap between rotary plate 11 and opposing component 50 (opposing component) to an extent where foreign objects cannot enter.

Specifically, in encoder 1 according to the present embodiment, although light-receiving part 40 is provided in fixed plate 21, in the same manner as in encoder 1X in the comparative example, the size of the gap (distance) between rotary plate 11 and opposing component 50 can be reduced to a size that is less than or equal to the thickness of light-receiving part 40. In other words, by interposing a portion of opposing component 50 between rotary plate 11 and fixed plate 21, the effective spatial dimensions above rotary plate 11 can be made small.

With encoder 1 according to the present embodiment as described above, since opposing component 50 is disposed between rotary plate 11 and fixed body 20, foreign objects can be prevented from entering between rotary plate 11 and fixed body 20. Specifically, foreign objects can be prevented from entering between rotary plate 11 and fixed plate 21. Accordingly, since foreign objects can be prevented from being deposited on code pattern 60, an encoder 1 that is highly robust to foreign objects can be realized.

Consequently, even if code pattern 60 is miniaturized, since the degradation of rotational displacement detection accuracy due to foreign objects can be inhibited, an encoder 1 with high resolution can be easily realized.

As most foreign objects (component burrs, chipped debris, and the like) that are deposited on code pattern 60 are larger than 1.5 mm in size, it is preferable to make the distance between rotary plate 11 and opposing component 50 less than or equal to 1.5 mm.

Furthermore, encoder 1 according to the present embodiment includes housing 70 for forming an enclosed space that encloses light-receiving part 40 in which light source 30 is provided, and glass cover 80 that opposes light-receiving part 40. Moreover, glass cover 80 is provided so as to cover the opening of frame-shaped housing 70.

With this configuration, since light source 30 and light-receiving part 40 can be disposed in an enclosed space, foreign objects can be prevented from being deposited on light source 30 and light-receiving part 40. Accordingly, robustness to foreign objects can be further increased.

Furthermore, in encoder 1 according to the present embodiment, housing 70 for forming an enclosed space and opposing component 50 are configured as a single component. Specifically, housing 70 is a portion of opposing component 50.

With this configuration, the number of additional components can be reduced compared to when housing 70 and opposing component 50 are provided as separate components. It should be noted that housing 70 and opposing component 50 may be provided as separate components.

### Embodiment 2

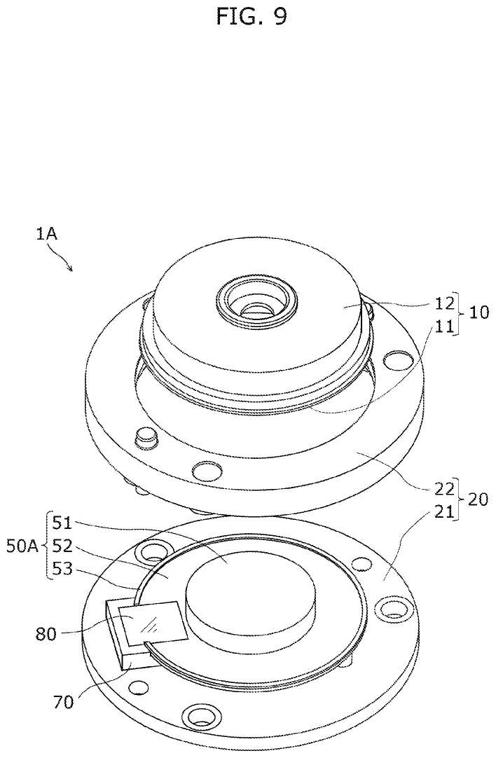

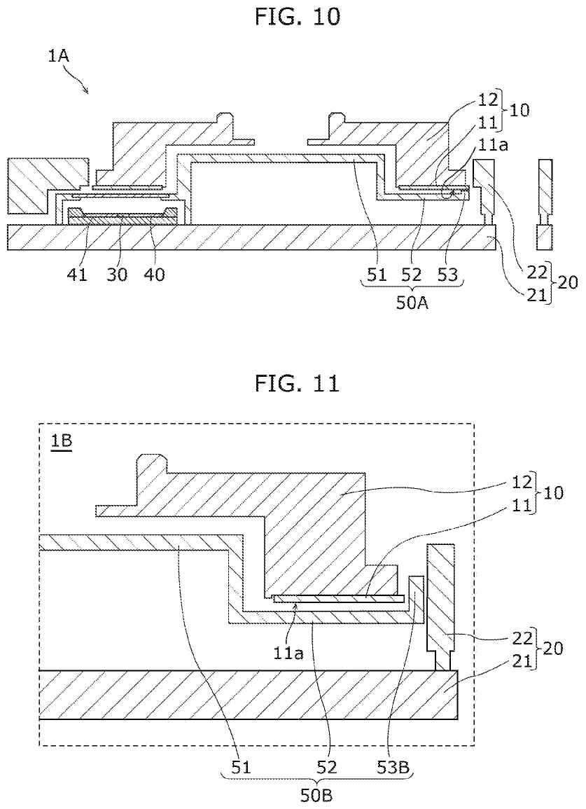

Next, encoder 1A according to Embodiment 2 will be described with reference to FIG. 9 and FIG. 10. FIG. 9 is an exploded perspective view of encoder 1A according to Embodiment 2. FIG. 10 is a cross-sectional view of encoder 1A. Note that in FIG. 10, only those portions visible in the cross section are illustrated.

As illustrated in FIG. 9 and FIG. 10, encoder 1A according to the present embodiment differs from encoder 1 according to Embodiment 1 above with regard to the structure of opposing component 50A.

Specifically, opposing component 50A according to the present embodiment further includes protruding portion 53 that protrudes toward rotary plate 11 in addition to cylindrical portion 51 and flange portion 52. Protruding portion 53 is disposed outside of code pattern 60 provided in rotary plate 11, and formed in an annular shape. In the present embodiment, protruding portion 53 opposes first surface 11a of rotary plate 11. In other words, protruding portion 53 protrudes so as to reduce the size of the gap between rotary plate 11 and flange portion 52 of opposing component 50A. Specifically, protruding portion 53 is formed in an edge portion of the outer circumference of flange portion 52, and opposes an edge portion of the outer circumference of rotary plate 11.

For example, the gap between the top surface of protruding portion 53 and first surface 11a of rotary plate 11 is less than or equal to 0.3 mm. As an example, when the gap between a surface of flange portion 52 (portion in which protruding portion 53 is not formed) and first surface 11a of rotary plate 11 is 1.5 mm, the gap between the top surface of protruding portion 53 and first surface 11a of rotary plate 11 is 0.3 mm. In other words, the height of protruding portion 53 is 1.2 mm. Note that protruding portion 53 is not in contact with flange portion 52.

Furthermore, annular protruding portion 53 is formed so as to project in the shape of a circle having a constant width. However, in the present embodiment, part of annular protruding portion 53 is cut out. Specifically, the part of protruding portion 53 that corresponds to a portion of housing 70 is cut out.

With regard to the configuration of elements other than opposing component 50A, encoder 1A according to the present embodiment has the same configuration as encoder 1 according to Embodiment 1 above.

Consequently, even in encoder 1A according to the present embodiment, since opposing component 50A is disposed between rotary plate 11 and fixed body 20, foreign objects can be prevented from entering between rotary plate 11 and fixed body 20. Accordingly, since foreign objects can be prevented from being deposited on code pattern 60, an encoder 1A that is highly robust to foreign objects can be realized.

Furthermore, in encoder 1A according to the present embodiment, opposing component 50A includes protruding portion 53 that protrudes toward rotary plate 11.

With this configuration, since foreign objects can be more readily prevented from entering between rotary plate 11 and fixed body 20, foreign objects can be even more readily prevented from being deposited on code pattern 60. Accordingly, robustness to foreign objects can be further increased.

Note that although protruding portion 53 of opposing component 50A opposes first surface 11a of rotary plate 11 in encoder 1A illustrated in FIG. 9 and FIG. 10, this example is not limiting.

For example, as in encoder 1B illustrated in FIG. 11, protruding portion 53B of opposing component 50B may protrude toward rotary plate 11 so as to oppose the side surface of rotary plate 11. Furthermore, protruding portion 53B is disposed outside of code pattern 60 provided in rotary plate 11, and formed in an annular shape. Encoder 1B according to the present variation also makes it possible to effectively prevent foreign objects from entering between rotary plate 11 and fixed body 20.

### Embodiment 3

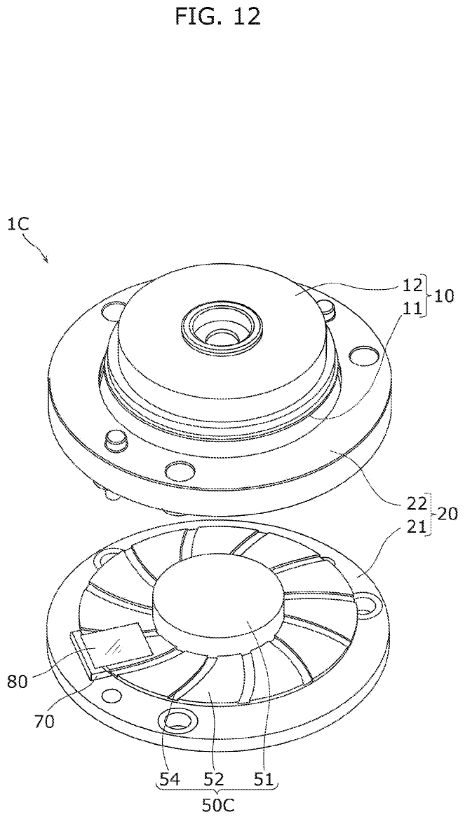

Next, encoder 1C according to Embodiment 3 will be described with reference to FIG. 12. FIG. 12 is an exploded perspective view of encoder 1C according to Embodiment 3.

As illustrated in FIG. 12, encoder 1C according to the present embodiment differs from encoder 1 according to Embodiment 1 above with regard to the structure of opposing component 50C.

Specifically, in opposing component 50C according to the present embodiment, grooves 54 are formed in an opposing surface of opposing component 50C that opposes rotary plate 11. Grooves 54 extend from an inner side of the opposing surface to an outer side of the opposing surface. In the present embodiment, grooves 54 are formed in a surface of flange portion 52 facing rotary plate 11.

Furthermore, a plurality of grooves 54 are provided in flange portion 52. Specifically, the plurality of grooves 54 are formed in a radial arrangement such that each groove is curved. As an example, the plurality of grooves 54 extend across the entire width of flange portion 52 so as to form a gentle spiral. In other words, the plurality of grooves 54 extend across the length from the connecting portion in flange portion 52, which connects to cylindrical portion 51, to the outer edge portion of flange portion 52.

With regard to the configuration of elements other than opposing component 50C, encoder 1C according to the present embodiment has the same configuration as encoder 1 according to Embodiment 1 above.

Consequently, even in encoder 1C according to the present embodiment, since opposing component 50C is disposed between rotary plate 11 and fixed body 20, foreign objects can be prevented from entering between rotary plate 11 and fixed body 20. Accordingly, since foreign objects can be prevented from being deposited on code pattern 60, an encoder 1C that is highly robust to foreign objects can be realized.

Furthermore, in encoder 1C according to the present embodiment, grooves 54 are formed in the opposing surface of opposing component 50C that opposes rotary plate 11.

With this configuration, even if a small foreign object, such as dust or the like (less than or equal to 1 mm in size, for example) were to enter between rotary plate 11 and fixed body 20, wind (pressure) generated when rotary plate 11 is rotated will cause the small foreign object to be pushed outward along groove 54. In other words, small foreign objects that enter between rotary plate 11 and fixed body 20 can be expelled outward by wind generated by the rotation of rotary plate 11.

### Variation

While the encoders according to the present disclosure have been described based on Embodiment 1 through Embodiment 3, the present disclosure is not limited to Embodiment 1 through Embodiment 3 above.

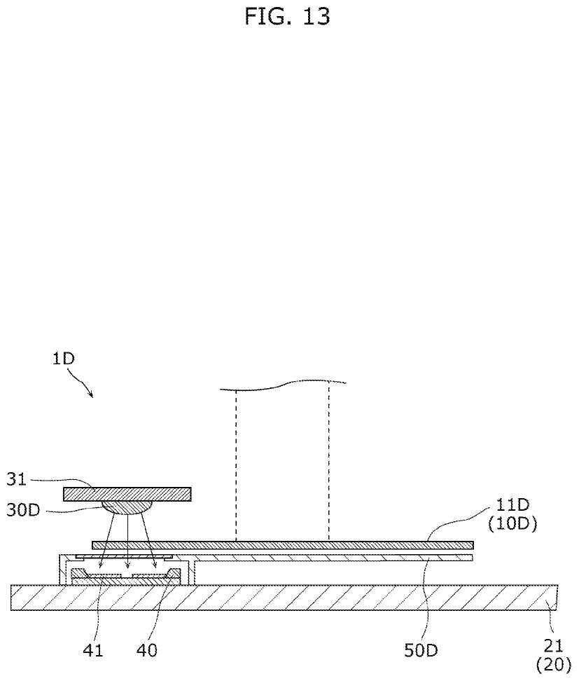

For example, in Embodiment 1 through Embodiment 3 above, although encoder 1 is an optically-reflective encoder, these examples are not limiting. Specifically, as illustrated in FIG. 13, the techniques of the present disclosure can also be applied to optically-transmissive encoder 1D. In such a case, in optically-transmissive encoder 1D, a code pattern provided in rotary plate 11D of rotary body 10D includes a plurality of light-transmissive portions (slits, for example) and a plurality of non-light-transmissive portions (light-shielding portions, for example). As an example of rotary plate 11D, a transparent plate, such as a glass plate or the like may be used. Furthermore, light source 30D is disposed so as to sandwich rotary plate 11D with light-receiving part 40. In other words, rotary plate 11D is disposed between light source 30D and light-receiving part 40. It should be noted that although light source 30D is provided in substrate 31 that is disposed separately from fixed plate 21, for example, this example is not limiting. Furthermore, in the present variation, although opposing component 50D does not include a cylindrical portion, and is configured to include a plate in which the surface facing rotary plate 11D is a flat surface, this example is not limiting. In other words, opposing component 50D may include a cylindrical portion. Furthermore, opposing component 50D according to the present variation may be applied to Embodiment 1 through Embodiment 3 above.

Furthermore, in Embodiment 1 through Embodiment 3 above, although absolute patterns 61 and incremental pattern 62 in code pattern 60 are provided across the entire circumference of rotary plate 11, this example is not limiting. Specifically, absolute patterns 61 and incremental pattern 62 in code pattern 60 may be provided in a portion of a rotary plate along the circumferential direction of rotary plate 11 at a predetermined inscribed angle.

Furthermore, in Embodiment 1 through Embodiment 3 above, although rotary plate 11 of encoder 1 includes both absolute patterns 61 and incremental pattern 62 as code pattern 60, this example is not limiting. Specifically, rotary plate 11 of encoder 1 need only include at least one of absolute patterns 61 or incremental pattern 62 as code pattern 60.

Forms obtained through various modifications to the foregoing embodiments that can be conceived by those skilled in the art, as well as forms realized by combining elements and functions in the foregoing embodiments without departing from the essence of the present disclosure are included within the scope of the present disclosure.

### INDUSTRIAL APPLICABILITY

The encoder according to the present disclosure is applicable in devices, such as motors and the like.

### REFERENCE SIGNS LIST

1, 1A, 1B, 1C, 1D encoder
2 rotary shaft
10, 10D rotary body
11, 11D rotary plate
11a first surface
11b second surface
12 support component
20 fixed body
21 fixed plate
22 fixed frame
30, 30D light source
31 substrate
40 light-receiving part
41 light-receiving region
50, 50A, 50B, 50C, 50D opposing component
51 cylindrical portion
52 flange portion
53, 53B protruding portion
54 groove
60 code pattern
61 absolute pattern
62 Incremental pattern
70 housing
80 glass cover

1. An encoder comprising:
a rotary plate including a pattern for detecting rotational displacement;
a light source that emits light onto the pattern;
a light-receiving part including a light-receiving region that receives the light that is emitted from the light source and travels via the rotary plate;
a fixed body in which the light-receiving part is provided; and
an opposing component that opposes the pattern, the opposing component being disposed between the rotary plate and the fixed body.

2. The encoder according to claim 1, wherein
a distance between the rotary plate and the opposing component is less than or equal to a thickness of the light-receiving part.

3. The encoder according to claim 1, wherein
a distance between the rotary plate and the opposing component is less than or equal to 1.5 millimeters.

4. The encoder according to claim 1, wherein
the opposing component includes a protruding portion that protrudes toward the rotary plate, and
the protruding portion is disposed outside of the pattern, and is annularly shaped.

5. The encoder according to claim 1, wherein
the light source is provided in the light-receiving part, and
the encoder further comprises:
a housing for providing an enclosed space that encloses the light-receiving part.

6. The encoder according to claim 5, wherein
the housing and the opposing component are configured as a single component.

7. The encoder according to claim 5, further comprising:
a glass cover that opposes the light-receiving part, wherein
the housing is frame shaped, and
the glass cover is provided to cover an opening of the housing.

8. The encoder according to claim 1, wherein
a groove is provided in an opposing surface of the opposing component, the groove extending from an inner side of the opposing surface to an outer side of the opposing surface, the opposing surface opposing the rotary plate.
